(19) United States
(12) Patent Application Publication
(10) Pub. No.: US 2015/0092166 A1
(43) Pub. Date: Apr. 2, 2015

(54) AUTOMATIC KEYSTONE CORRECTION IN AN AUTOMATED LUMINAIRE

(71) Applicants: Pavel JURIK, Prostredni Becva (CZ); Josef Valchar, Prostredni Becva (CZ)

(72) Inventors: Pavel JURIK, Prostredni Becva (CZ); Josef Valchar, Prostredni Becva (CZ)

(21) Appl. No.: 14/042,762

(22) Filed: Oct. 1, 2013

(51) Int. Cl. H04N 9/31

(52) U.S. Cl. CPC H04N 9/3185
USPC 353/70

(57) ABSTRACT

Described is a dynamic correction of keystone distortions of a dynamically panning and tilting luminaire projecting on a flat projection surface. When the luminaire is panned and/or tilted the proper degree of keystone correction is applied. Further the system dynamically corrects for varying of intensity of different parts of the projected image due to the none linear distribution of light on the projection surface as the luminaire is dynamically panned and or tilted relative to the projection surface.

### TECHNICAL FIELD OF THE INVENTION

The present invention generally relates to the projection of images and more specifically to the projection of images from an automated luminaire and digital imaging systems used for the correction of images when projected onto a planar surface.

### BACKGROUND

Projection systems are commonly used in many different entertainment and commercial applications. Such products are commonly used in theatres, television studios, concerts, theme parks, night clubs and other venues. These systems may be used to project content from video sources such as DVD players or video cameras or may project a video stream that is computer generated. One application for such devices is as a digital light where a video projection system is used as a lighting instrument giving the user full control over the imagery, color, patterns and output of the luminaire. An example of such a system is the Digital Spot 7000 DT from Robe Lighting.

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The automated digital automated luminaires discussed in this invention is a combination of an automated light and a digital luminaire.

In many cases the imagery used in these digital automated luminaires is produced by a media server. A media server may be a computer based system which allows the user to select a video image from an external library, manipulate and distort that image, combine it with other images and output the completed imagery as a video stream. Examples of some of the many different manipulations available might include image rotation & scaling, overlaying multiple images and color change.

A common manipulation provided in prior art systems is the ability to apply keystone correction to a projected image. FIG. 1 illustrates a prior art system with a projector 1 and an object or screen 2 with a projection surface. The axis of projection 4 for projector 1 is perpendicular to the projection surface and the projected beam 3 is thus symmetrical on the projection surface 2 about the axis 4. Source image 10 (which may be generated as the output from a media server) is sent to the projector 1 which then outputs it as viewed image 710 on the projection surface of object 2. The relative proportions of source image 10 are unchanged by the projection process into the viewed image 7. In particular, in this example, left source image height 8 is equal to the right source image height 9 and left viewed image height 5 is equal to the right viewed image height 6. Projection has not distorted the image.

FIG. 2 shows the situation where projector has been moved and the axis of projection 4 for projector 1 is rotated from the first position such that it is no longer perpendicular to the projection surface of object 2. Although source image 10 is unchanged and the left source image height 8 is equal to the right source image height 9, because of the difference in path lengths between the right and left hand edges of the projected beam 3 this is no longer true for the viewed image and the left viewed image height 5 is greater than the right viewed image height 6. This leads to the trapezoidal distortion of the viewed image 7 shown in FIG. 2. This distortion is commonly known as keystone distortion due to the keystone shape of the viewed image.

To correct for this distortion in the viewed image it is known to apply a prior and compensatory distortion to source image 10 as illustrated in FIG. 3. Now source image 10 is pre-distorted such that the left source image height 8 is less than the right source image height 9. The amount of pre-distortion is chosen such that the viewed image 7 is fully corrected and the left viewed image height 5 is once again equal to the right viewed image height 6. Although such pre-distortion corrects the shape of the projected image it does not correct the intensity variations across the image due to differences in angle and distance. In the example shown in FIG. 3 the right side of the image 6, which is closer to the projector, will be higher in intensity than the left side 5.

The manipulation of the image to correct for keystone correction in this manner may be undertaken either in the media server generating the images or within the projector 1. Although the illustrations here cover keystone correction in a single, horizontal, axis it is known in the art to provide this correction on both the vertical and horizontal axes either simultaneously or separately to correct for all off axis projection situations. An example of a product utilizing such keystone correction is the Digital Spot 7000 DT from Robe Lighting.

It is further known in the art to provide such keystone correction in a semi-automatic manner with a static projector where a projector may be moved to a new position on the same projection surface, and the projector is capable of adjusting the keystone correction such that the image in the new position is also keystone corrected. However, current systems providing this function do not have the ability to continuously and dynamically amend keystone correction to deal with an image from a moving digital automated luminaire. Instead they provide keystone correction for a repositionable projector that is not continuously moving but instead moves from a first static position to a second static position.

It would be advantageous to provide a system which was capable of providing continuous and dynamic keystone correction to images from a digital automated luminaire as it is moved across a planar projection surface.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an on axis projection system;

FIG. 2 illustrates an off axis projection system;

FIG. 3 illustrates an off axis projection system with keystone correction;

FIG. 4 illustrates an off axis projection system with keystone correction;

FIG. 5 illustrates possible positions for projection onto a planar surface;

FIG. 6 illustrates possible positions for projection onto a planar surface and the associated keystone correction provided;

FIG. 7 illustrates a flow chart for an embodiment of a dynamic keystone correction algorithm;

FIG. 8 illustrates major components of a luminaire control desk embodiment with dynamic keystone correction; and

FIG. 9 illustrates a flow chart for an embodiment of a dynamic light intensity correction algorithm.

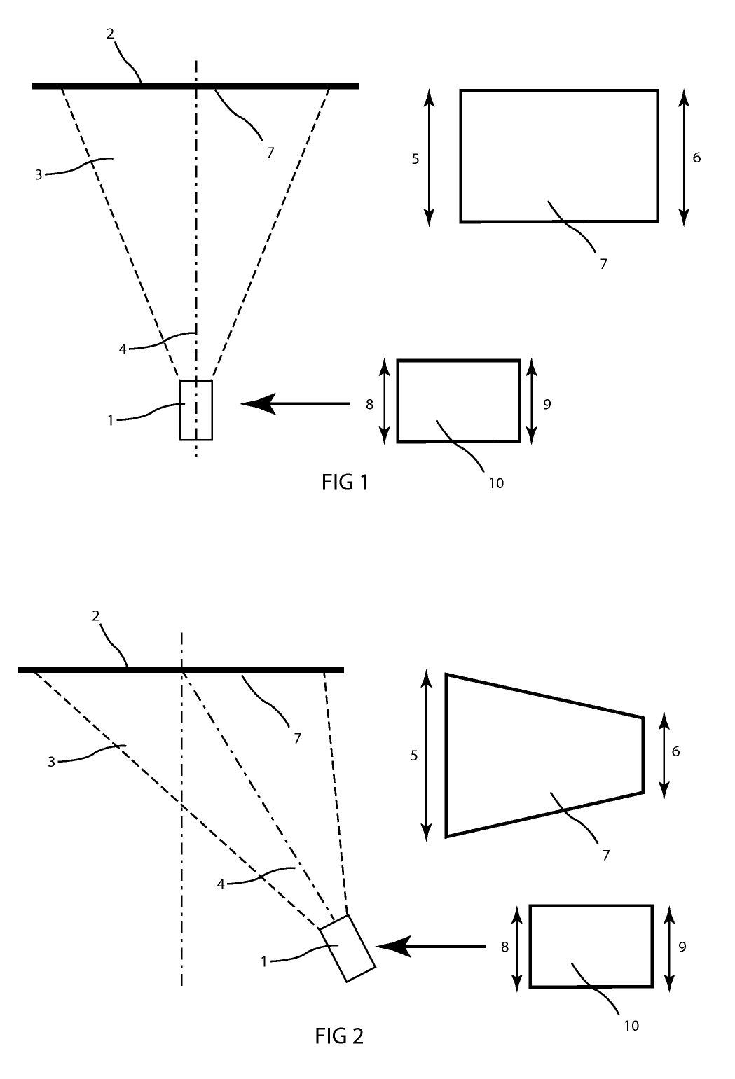

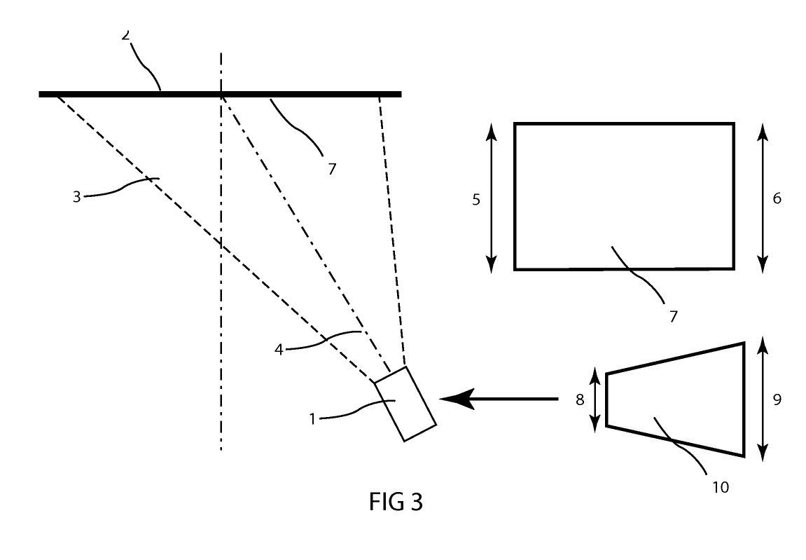

### DETAILED DESCRIPTION OF THE INVENTION

Preferred embodiments of the present invention are illustrated in the FIGUREs, like numerals being used to refer to like and corresponding parts of the various drawings.

The present invention generally relates to the projection of images and more specifically to digital imaging systems used for the correction of images when projected onto multi-planar surfaces

In one embodiment the present invention utilizes a projection system with an associated means for providing pre-distortion of an image. Such means may be within the projection system or may be provided by an external processor or media server.

FIG. 5 illustrates possible positions for projection onto a single planar surface 2. When the digital automated luminaire is fully normal to planar projection surface 2 then the image will be undistorted 20. Rotating the digital automated luminaire about a horizontal axis to a new position would produce the distortions shown as 21 and 25. Similarly, rotating the digital automated luminaire about a vertical axis to a new position would produce the distortions shown as 23 and 27. Rotating about both axes would produce the combined distortions shown as 22, 24, 26, and 30. As the rotation angle of the digital automated luminaire is under the control of the motor system operating the light these rotation angles are known and, thus, the necessary keystone correction for each case can be applied to pre-distort the image such that corrected images can be projected. These are illustrated by the dashed lines in FIG. 6 within each of the projected images 21, 22, 23, 24, 25, 26, 27, 30.

For this calculation and pre-distortion to be carried out it is necessary for the control system to have information on the rotation angle of the digital automated luminaire. It The system also requires information regarding the orientation of the planar surface with respect to the digital automated luminaire. The rotation angle is already known, but the orientation is not as it is a function of how the digital automated luminaire and projection surface were installed.

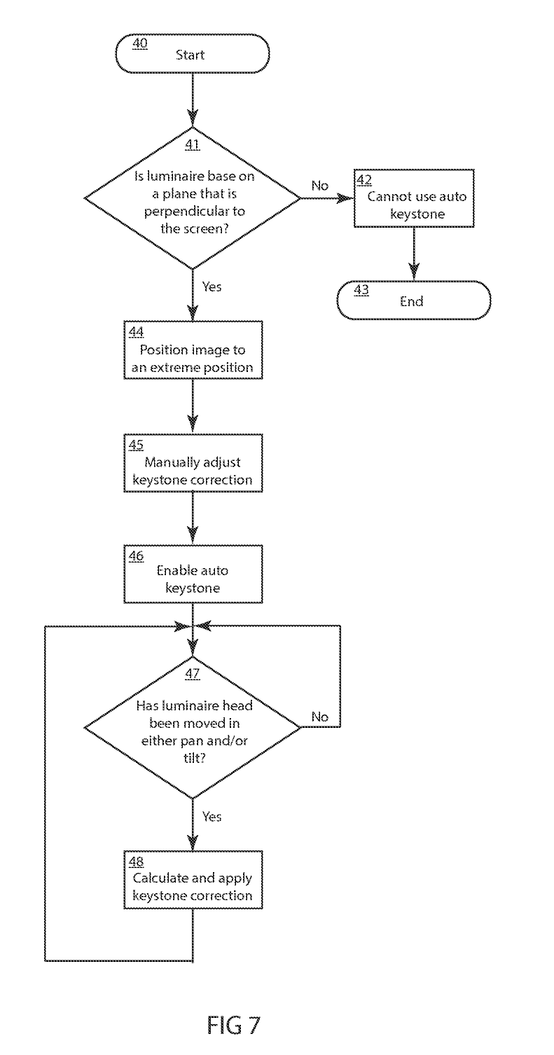

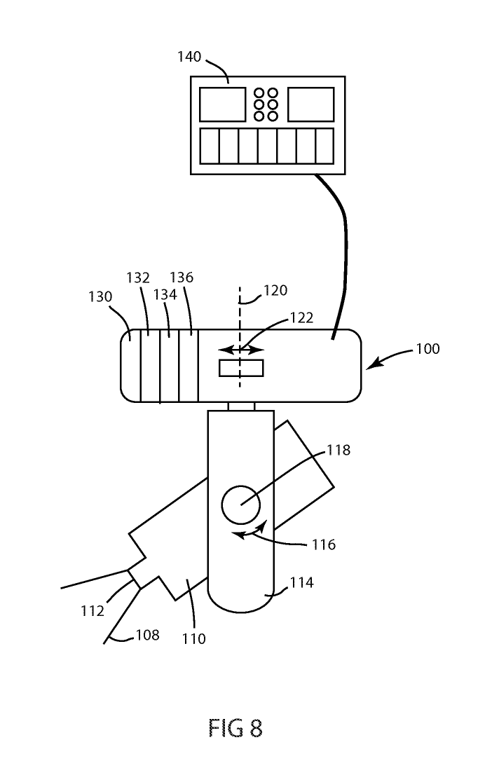

The invention seeks to provide the information on the orientation of the planar surface with respect to the digital automated luminaire through a single calibration step performed by the operator. In the described embodiment of the invention the system assumes that the digital automated luminaire is mounted with its base on a plane that is perpendicular to the plane of the screen or projection surface. The digital automated luminaire may be at any angle to the screen or projection surface in the other two planes, but at least one plane, the base, must be perpendicular. FIG. 7 illustrates the flow chart for implementing automated dynamic key stone correction.

The process starts at step 40, then moves to step 41 where the system determines, either automatically through internal accelerometers or through operator input, if the luminaire base is on a plane perpendicular to the screen. If it isn't then we cannot use the automatic keystone correction function 42 and the process terminates 43. If the base is positioned appropriately, then we move to operation 44 and the operator will rotate the digital automated luminaire, in one or both of the movement axes, so as to position the image to an extreme position on the projection screen. Ideally a position such as 22, 24, 26, 30 in FIG. 5. Using an extreme position for the calibration step is not necessary for the algorithm, and any position will suffice, however using an extreme position, where rotation on both axes is used, increases the accuracy of the calculation and makes it easier for the operator to achieve a good result. Once the digital automated luminaire is positioned at the calibration position, for example position 30 in FIG. 5, then the operator will manually adjust the keystone correction for this position to obtain the result shown by the dashed line in FIG. 6 for position 30 where the image appears rectangular and undistorted. The operator now indicates to the system in the digital automated luminaire, via a control channel or by other means such as a push button, switch, or other means well known in the art, that the image is now correctly keystone corrected and that automatic keystone correction should be enabled 46.

The system of the invention now has knowledge of the manually applied keystone correction required for, in this example, image position 30 which represents known rotation angles of the digital automated luminaire. From this data, and the already stated requirement that the luminaire base is on a plane perpendicular to the screen, the system can calculate the three dimensional plane of projection surface 2 relative to the plane of the base of the digital automated luminaire. This is necessary and sufficient data to be able to calculate the keystone correction required for any other projection position on that same three dimensional plane achievable through rotation in two axes, commonly known as pan and tilt, of the digital automated luminaire. Thus, using the known rotation angles of the digital automated luminaire 47 the system can continuously and dynamically calculate and apply keystone correction 48 to the image ensuring that the image is always presented undistorted anywhere on screen 2.

As previously stated, although an extreme calibration position yields the best accuracy and is easiest for the user to define, any position(s) of the image on screen 2 can be used for calibration.

FIG. 8 illustrates the control system. Note that the system in comprised of the control desk 140 and the luminaire 100. The luminaire is able to position the light beam output 108 about axis 120 and axis 118 respectively: pan 122 by rotating arm(s) 14 (only one side shown in this figure) and tilt 116 by rotating the housing 110 holding the light engine (not shown) In the embodiment shown the luminaire includes: electromechanical devices 130 for physically moving optical components, electronic circuitry for driving the electromechanical devices 132 firmware and software containing stored routines 134 and electronic circuitry for control communications, and data processing and acting as a media server. The routines discussed herein are processed by the luminiare's circuitry and software 134 and 136. However in other embodiments this level of processing might be reserved for the control desk 140.

In one embodiment of the invention the control system for moving the luminaire is provided through a data signal using the industry standard DMX512 protocol. The DMX512 protocol has a standard data refresh rate of approximately 44 Hz and the keystone correction system of the invention will calculate new keystone correction values at a minimum of the same 44 Hz rate such that the image is always keystone corrected, with no perceptible time lag between movement and correction.

In another embodiment of the invention the internal motor control system runs with a motor refresh rate significantly faster than the DMX512 rate of 44 Hz and the keystone correction system of the invention will calculate new keystone correction values at a rate intermediate between the 44 Hz DMX512 refresh rate and the internal motor system refresh rate such that the image is always keystone corrected, with no perceptible time lag between movement and correction.

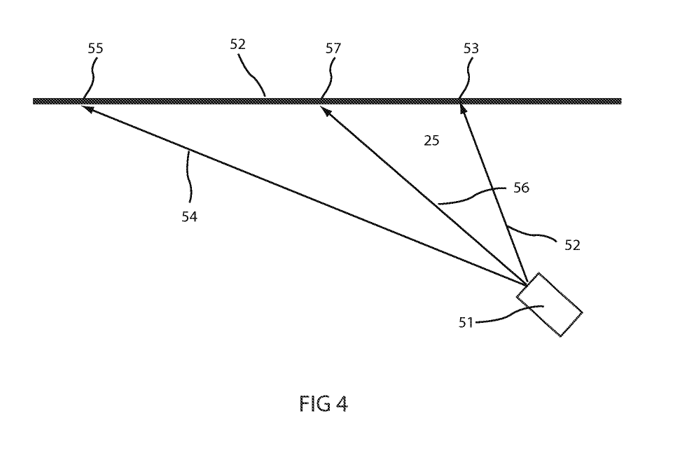

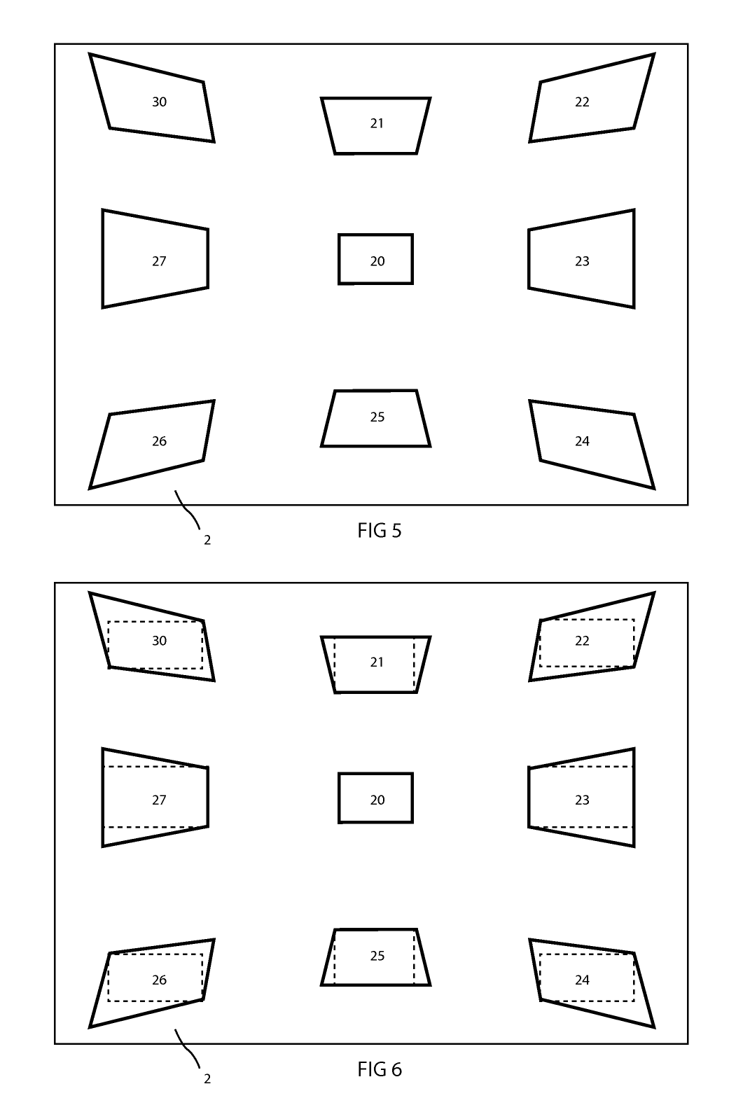

In addition to the geometric distortions and corrections described above there is a further form of distortion introduced by off axis projection, that of brightness or intensity distortion. FIG. 4 illustrates an off axis projection where digital automated luminaire 51 is projecting an image onto screen 52. It can be seen that the projection distance for one side of the beam 52 is shorter than the projection distance for the other side of the beam 54. If the projector 51 is outputting a uniformly bright image then point 53 will be brighter than point 55. The brightness difference between points 53 and 55 may be calculated using the well-known inverse square law for light propagation. A further embodiment of the invention corrects for this brightness difference by calculating and applying a brightness variation across the field of the projection to counteract the brightness difference caused by the path length differences introduced by an off axis projection. In the example illustrated in FIG. 4 the projected beam 52 impinging the object at point 53 would be reduced in brightness by an amount necessary to match that of beam 54 impinging the object at point 55. Such correction may be input manually by an operator or may be automatically calculated by the system using known data on the positions of digital automated luminaire 51 and the plane of screen 52.

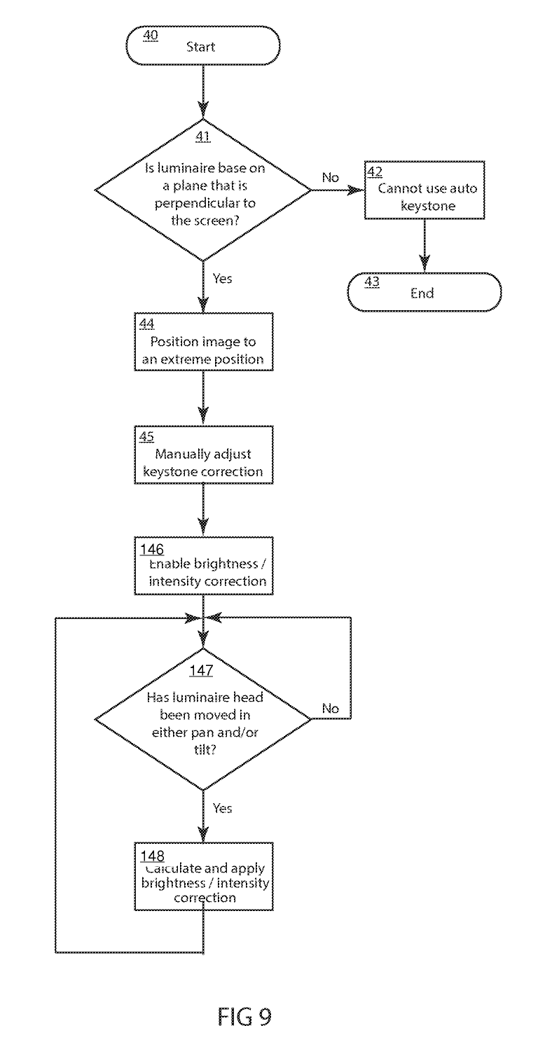

FIG. 9 illustrated an embodiment of a routine for implementing automated dynamic light intensity correction due to non even distribution of the light beam due to the beam projection angle relative to the projection surface. In the embodiment shown the intensity corrections are based on the keystone distortion. For this reason steps 41, 42, 43, 44, and 45 are the same as in FIG. 7. However, in other embodiments the user manual intensity corrections may be more direct to this parameter in step 45. In this embodiment after the user makes the extreme position keystone corrections, the automatic, dynamic brightness correction can be enabled/turned on 146. Then any time the pan or tilt is adjusted 147, the intensity may be corrected 148 as discussed above.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims

We claim.

1. An automated multiparameter luminair system comprising
light source for generating a light beam;
actuators for dynamically panning and/or tilting the position of the light beam on a flat projection surface;
data processing routines for determining keystone corrections based on the calculated position(s) of the light beam on the projection surface where the corrections are made dynamically, and automatically when the actuators change the pan and or tilt position of the light beam on the projection.

2. The automatic mulitparameter luminaire system of claims 1 where the
user control manually makes keystone correction for a plurality of light beam positions; and
the determination of keystone correction is also based on the user made manual keystone corrections.

3. The automatic mulitparameter luminaire system of claims 2 where there is no perceptible lag time between pan and/or tilt movement and the keystone correction.

4. The automatic mulitparameter luminaire system of claims 2 where the data processing also determines and corrects for light intensity based on the keystone corrections.

5. An automated multiparameter luminair system comprising
light source for generating a light beam;
actuators for dynamically panning and/or tilting the position of the light beam on a flat projection surface;
data processing for determining light intensity corrections for the projection of an image that has keystone distortions due to the projection angle of the light source on the projection surface.

6. The automatic mulitparameter luminaire system of claims 5 where the
user control manually makes keystone correction for a plurality of light beam positions; and
the determination of intensity correction is also based on the user made manual keystone corrections.

7. The automatic mulitparameter luminaire system of claims 5 where there is no perceptible lag time between pan and/or tilt movement and the light intensity correction.
